(19) United States
(12) Patent Application Publication
(10) Pub. No.: US 2025/0223071 A1
(43) Pub. Date: Jul. 10, 2025

(54) POUCH FOR A POUCH SORTER, A CORRESPONDING POUCH SORTER AND A METHOD FOR AUTOMATIC POUCH UNLOADING

(71) Applicant: BEUMER GROUP GMBH & CO. KG, Beckum (DE)

(72) Inventors: Nils NEUMANN, Rheda-Wiedenbrûck (DE); Christopher Philipp KIRSCH, Schwerte (DE)

(21) Appl. No.: 18/977,332

(22) Filed: Dec. 11, 2024

(30) Foreign Application Priority Data
Jan. 10, 2024 (EP) 24151189.8

(51) Int. Cl. B65B 69/00; B65G 9/00

(52) U.S. Cl. CPC B65B 69/0008; B65G 9/002; B65G 2201/0235

(57) ABSTRACT

A pouch (1) for a pouch sorter, wherein the pouch (1) has a divisible pouch base (2) with two pouch base halves (2.1, 2.2) which are connected to one another via a locking mechanism (3) and can be released from one another in a release position of the locking mechanism (3), wherein the locking mechanism (3) can be adjusted back and forth between a closed position and the release position by a drive (4), wherein the drive (4) has a shape memory element (5, 12) which can be supplied with an electric current via an electric power supply (7) of the pouch (1). Furthermore, a corresponding pouch sorter and a corresponding method are described.

### CROSS-REFERENCE TO RELATED APPLICATIONS

This application claims the benefit and priority of European Patent Application 24151189.8 filed Jan. 10, 2024. The entire disclosure of the above application is incorporated herein by reference.

### BACKGROUND OF THE INVENTION

### Technical Field

The invention relates to a pouch for a pouch sorter, a corresponding pouch sorter and a method for automatic pouch unloading in a pouch sorter.

### Discussion

EP 4 168 330 A1 describes a pouch for a pouch sorter, wherein the pouch has a divisible pouch base with two pouch base halves which are connected to one another via a locking mechanism and can be released from one another in a release position of the locking mechanism, wherein the locking mechanism can be adjusted back and forth between a closed position and the release position by a drive.

Drives with a thermally activatable shape memory element are known from DE 10 2017 106220 B3 and from DE 10 2019 211078 A1.

Such pouches are used in particular for pouch sorters in which automatic pouch unloading in which no operating personnel are required for unloading the pouch is provided. In common applications, the pouch sorters have a plurality of 10,000 pouches which can in each case be equipped with a locking mechanism actuated by a drive. The pouches known from the prior art have the disadvantage that the locking mechanism is mechanically complex and therefore not cost-effective, but is designed to be susceptible to malfunction. Owing to the high number of pouches, however, reliable operation of the locking mechanism is indispensable, wherein the costs per pouch must at the same time be kept as low as possible.

It is therefore the aspect of the invention to further develop a pouch of the type described at the outset in such a way that it can be used cost-effectively in production and in a process-reliable manner for automatic pouch unloading.

### SUMMARY

Accordingly, in the case of a pouch it is provided that the locking mechanism has a shape memory element which can be supplied with an electric current via an electric power supply of the pouch. The use of a shape memory element which provides the force required for actuating the locking mechanism has the advantage that it can be operated substantially wear-free and therefore in a process-reliable manner over a plurality of 1000 closure cycles.

The shape memory element can be of substantially rod-shaped or wire-shaped design, in particular have a length which is many times greater, for example at least ten times as great, preferably at least one hundred times as great, as any further dimension, for instance a width, or a diameter, or a thickness of the shape memory element. For example, the shape memory element can have a wire or be designed as an electrically conductive wire which has a shape memory alloy. In particular, the shape memory element can be designed as a spring made of an electrically conductive wire of a shape memory alloy, for example as a spiral spring or a helical spring.

The shape memory element can be configured to experience a contraction or an enlargement, in particular a length contraction or an extension, when the shape memory element is supplied with an electric current via the electric power supply of the pouch. In the course of the contraction or enlargement, the shape memory element can exert a force on at least one pawl of the locking mechanism, which can be configured to be pulled out of a recess of the pouch base when the locking mechanism is transferred from the shape memory element into the release position.

The shape memory element can have or consist of a shape memory alloy, for example nitinol. The shape memory element can be an actuator or a component of an actuator. The shape memory element can accordingly be designed as a shape memory actuator. The actuator can be a linear actuator. The actuator can have, for example, a nominal force of 5 N. The actuator can have an overload protection which corresponds, for example, to one to twice the nominal force.

Such a suitable shape memory actuator can have a combination of MSM (magnetosensitive materials) and SMA (shape memory alloy) materials. This combination allows the actuator to hold various positions passively by means of the holding force of the MSM material. The actuator operates with minimal mechanical wear and generates a passive holding force in each position, as a result of which it is very energy-efficient.

The actuator can have, for example, two SMA wires and one MSM element. The MSM element can allow the passive holding of the position, while the SMA elements operate antagonistically in order to generate tensile or compressive forces. In order to initiate a movement, the SMA elements must overcome the self-holding force of the MSM element. If an external force exceeds the internal holding force of the MSM element, it deforms and serves as overload protection.

In order to absorb high forces in a primary loading direction, the actuator can be supported by additional components such as springs or a magnetic field (e.g. a permanent magnet).

Alternatively, an actuator can also consist of a single SMA and MSM element. In this case, a temperature regulation and a controllable magnetic field are required for the activation, wherein the MSM acts as an active component or restoring element.

However, the implementability of the invention is not restricted to the actuators described above with multi-part shape memory elements. In particular, in one embodiment, the shape memory element can have or consist of only a single wire of a shape memory alloy. MSM elements can be dispensed with entirely, since their holding function is not mandatory for the implementation of the invention.

The pouch base can have a first and a second pouch base half, wherein one of two opposite side walls of the pouch is fastened to each of the two pouch base halves. As a result of the separation of the two pouch base halves in the course of the transfer of the locking mechanism from the closed position into the release position, the two pouch base halves can be separated from one another and the pouch can open on the bottom side so that a transported good received in the pouch can fall out of the pouch by gravity. The pouch base walls can be manufactured in particular from a flexible material, for example from a textile. This makes it possible that, after the unloading of the pouch, the two opposite side walls of the pouch come to bear against one another or at least approach one another up to a minimal distance so that the two pouch base halves come into contact with one another and the locking mechanism can lock the two pouch base halves to one another in that it is transferred from the release position into the closed position by the shape memory element. This transfer can take place in that the power supply of the shape memory element is interrupted. This has the consequence that the above-described dimensional change, in particular length change of the shape memory element, for example an increase in length or a reduction in the length of the shape memory element, drives a pawl to enter a recess of the pouch base, in particular one of the two pouch base halves, and thus to fix the two pouch base halves to one another.

For reclosing the two pouch base halves separated from one another after the pouch unloading, it can be provided that a plurality of pouches, for example a pouch batch which has been guided over a pouch unloader and at least one of the pouches of the batch has been unloaded at the pouch unloader, are stowed in the conveying direction following the pouch unloader so that the side walls of the stowed pouches are pressed against one another and thus the pouch base halves are brought together. If the shape memory element is thereupon relaxed owing to the interrupted power supply and the locking mechanism is transferred from the open position into the closed position, the two pouch base halves of the pouch can be connected to one another again, in particular locked to one another.

Preferably, one of the two pouch base halves has the actuator system described above, in particular the shape memory element and at least one pawl driven thereby. The other pouch base half can have at least one recess for receiving the locking pawl when the locking mechanism is arranged in the closed position. Otherwise, the other pouch base half can be free of components, in particular free of movable parts, of the locking mechanism. It can thus be provided that, apart from the recess, all the components of the locking mechanism are restricted to one of the two pouch base halves.

The locking mechanism can be received at least partially in a cavity in one of the two pouch base halves. Preferably, the shape memory element, in particular a wire made of a shape memory alloy, can be guided at least over substantial parts of its length substantially without contact to further structural components of the pouch base half through the cavity. The freedom from contact allows a short reaction time of the shape memory element in that, during heating, the heat transfer to adjacent components of the pouch base is avoided. Furthermore, the cavity allows flow around the shape memory element when the power supply is intended to be interrupted and the shape memory element is intended to cool down for relaxation. Preferably, the cavity through which the shape memory element is guided is open on one side of the pouch base half which has the shape memory element and receives it in the cavity when the two pouch base halves are separated from one another in the release position of the locking mechanism, and is closed by the opposite pouch base half when the two pouch base halves are fixed to one another in the closed position. This allows the air flow around the shape memory element to be prevented in the closed position and thus unnecessary heat dissipation to be avoided when current is supplied.

The first and the second pouch base half can have aids for combining the two pouch base halves after the pouch has been emptied, so that the two pouch base halves can be fixed to one another again, for example after an interruption of the power supply of the shape memory element, in particular of the shape memory element, in that the locking mechanism is transferred from the release position into the closed position. The aids can have at least a pair of elements which attract one another magnetically, for example a permanent magnet and a metal which can be magnetized by the permanent magnet or a pair of permanent magnets of opposite polarity. The permanent magnet can be arranged on a first of the two pouch base halves and the magnetizable metal or the magnet of opposite polarity can be arranged in a second of the two pouch base halves. At least one of permanent magnet and magnetizable metal/magnet of opposite polarity can be driven by the locking mechanism in such a way that the permanent magnet and the magnetizable metal or the magnet of opposite polarity are closer together in the closed position than in the release position.

The two pouch base halves can be of plate-shaped or rod-shaped design. The shape memory element, in particular an electrically conductive wire made of a shape memory alloy, can extend in the interior and at least in sections, preferably over its entire length, parallel to one of the two pouch base halves. If the shape memory element is designed as a spring made of an electrically conductive wire of a shape memory alloy, for example as a spiral spring or a helical spring, the shape memory element can extend with its axis of symmetry, in particular with its longitudinal axis, at least in sections parallel to one of the two pouch base halves. The shape memory element, in particular an electrically conductive wire thereof, for example a spiral spring or a helical spring made of the electrically conductive wire of a shape memory alloy, can be electrically and/or thermally insulated. The insulation can be applied to the wire, for example as a lacquer. The insulation can be conditioned in such a way that, despite its insulating properties, it still ensures sufficient mobility of the shape memory element.

The shape memory element, in particular an electrically conductive wire made of a shape memory alloy, can be arranged exposed in the interior of a cavity of the pouch bottom half. The cavity can be open at a connecting side, via which the pouch bottom half bears against the other pouch bottom half when the pouch bottom halves are connected to one another, when the pouch bottom halves are detached from one another.

The locking mechanism can be pretensioned into the closed position. The pretension can be provided with the aid of a spring element, for example with a spiral spring. The spring element can act on a locking pawl which can be moved back and forth between an extended position and a retracted position with the aid of the locking mechanism. The locking pawl can be formed on a lever which is pivotable about an axis of rotation. The shape memory element can be configured to pivot the lever about the axis of rotation and thus to drive the locking pawl at least in one of the two movement directions between the extended position and the retracted position. The opposite direction of the movement of the locking pawl can be provided by a spring element acting in the opposite direction. The spring element can be the spring element which provides the pretension into the closed position described above.

The spring element and the shape memory element can be spring elements acting in opposite directions, wherein the shape memory element has an adjustable spring constant depending on the current supply. In particular, the spring element and the shape memory element can exert opposite torques on the lever. While the spring element, in both cases a spiral spring, has an invariable spring characteristic, the spring force exerted by the shape memory element can be adjustable depending on the current supply.

The shape memory element can be designed as a tension spring or as a compression spring. The same applies to the spring element. Accordingly, the shape memory element and the spring element can be interchanged with one another in the sense of a kinematic reversal in embodiments of the invention.

In the closed position of the locking mechanism, the locking pawl can assume the extended position while it assumes the retracted position in the release position of the locking mechanism. So that the locking mechanism assumes the release position, it can be provided that the shape memory element is supplied with an electric current via the power supply, whereupon the shape memory element changes its length, in particular contracts or relaxes, and thereby pivots the lever about the axis of rotation in such a way that the locking pawl is transferred from the extended position into the retracted position. Accordingly, the locking mechanism can have, for example, at least one lever which is pivotable about an axis of rotation and on which the shape memory element and a locking pawl are arranged spaced apart from one another in the longitudinal direction of the lever. Preferably, the locking mechanism can have on opposite sides of one of the pouch bottom halves, preferably on opposite end faces, in each case a lever which is pivotable about an axis of rotation. Spaced apart from one another in the longitudinal direction of the lever, the shape memory element on the one hand (or shape memory elements separate for both levers) and a locking pawl on the other hand can be arranged.

In one embodiment, the locking pawl can thus extend out of the pouch bottom half over one of two opposite end faces of one of the two pouch bottom halves when the locking mechanism assumes the closed position. In this case, the shape memory element, in particular an electrically conductive wire made of a shape memory alloy, can preferably extend at least in sections and preferably over its entire length at an angle, preferably perpendicularly, to the end face.

Preferably, a locking pawl of the locking mechanism is formed on each of the two opposite end faces. The two locking pawls can be driven with in each case one shape memory element or with the same shape memory element.

To increase the effective length, the shape memory element, in particular an electrically conductive wire made of a shape memory alloy, can have at least one deflection, for example a 180° deflection, so that the shape memory element, in particular the wire, is guided at least in sections in parallel tracks.

The locking mechanism can accordingly have a spring element with which the locking mechanism is pretensioned into the closed position. The shape memory element can be configured to transfer the locking mechanism into the release position against a pretension of the spring element depending on a current supply.

In order to supply electric energy to the pouch, it can have at least one electric contact, preferably at least one sliding contact, for connecting a current source, for example a direct current source, to the electric power supply. In this embodiment, it can be provided that the pouch is supplied with electric energy only at the time of the unloading process and is otherwise currentless. A separate open-loop and closed-loop control mechanism for the actuation of the locking mechanism is thus not required. An energy store, for example an electrochemical energy store, which would have to be accommodated in the pouch is also not required.

Furthermore, it is advantageous if the pouch is currentless along the conveying section of the pouch sorter and is supplied with electric energy only for the actual unloading process. The electric contact can be provided in an upper region of the pouch. The electric contact can be designed in particular on a carrier which is suspended in a conveying rail of the conveying section and into which the pouch is suspended and driven along the conveying section. The electric power supply can provide in particular a power line between the electric contact and the locking mechanism, in particular the shape memory element. The power line can be designed as a flexible, preferably multi-core electric cable.

At a pouch unloader along a conveying section of the pouch sorter, a current source, for example a direct current source, can be provided which comes into contact with the electric contact, for example a sliding contact of the pouch, at a specific unloading position and supplies the current supply of the pouch with electric energy. The current source can have a contact which is complementary to the contact of the pouch, for example a similar or complementary sliding contact. The tolerance of the unloading position results precisely from the contact distance of the complementary contacts when they come into contact with one another during the transport of the pouch along the pouch unloader. If the contact distance is kept small in that the dimensions of the complementary contacts in the conveying direction of the pouch are kept small, a low tolerance of the unloading position can be maintained. This allows the pouch not to have to be slowed down or even stopped for the unloading process. Rather, the pouch can be guided past the pouch unloader and unloaded at unchanged speed along the conveying section. By suitable design of the lever and of the effective length of the shape memory element, in particular of the electrically conductive wire made of a shape memory alloy, very short reaction times of the shape memory element can be achieved and thus the required duration of the current supply can be kept short.

The power supply can have at least one electric conductor, for example an electric cable, with which the shape memory element is connected to the at least one electric contact.

The power supply of the electric power supply can alternatively be designed to be contact-free. For this purpose, the electric power supply can have at least one receiver of a wireless, preferably an inductive, energy transmission, by which the power supply is supplied with electric energy. The pouch unloader can have a transmitter of a wireless, preferably an inductive, energy transmission. Analogously to the complementary electric contacts of pouch and pouch unloader described above, even in the case of a power supply designed to be contact-free, for example by suitable shielding of the transmitter of the wireless energy transmission, a very high precision with regard to the unloading position can be achieved.

A pouch sorter can have a multiplicity of pouches of the type described above, wherein the pouch sorter has an overhead conveyor with a multiplicity of carriers, which are conveyed along a conveying rail of the overhead conveyor and into which in each case one of the multiplicity of pouches is suspended.

According to another aspect of the invention, a method for the automatic pouch unloading in a pouch sorter is described, wherein the method has the steps:
a. conveying at least one pouch of the type described above, preferably a multiplicity of these pouches, particularly preferably a batch of a specific number of these pouches, along a conveying section of a pouch sorter;
b. feeding the pouch into a pouch unloader of the pouch sorter along the conveying section, wherein at the pouch unloader the locking mechanism is actuated to assume the release position by the shape memory element being supplied with an electric current from the pouch unloader via the power supply.

The supplying can comprise heating of the shape memory element, wherein a length of the shape memory element, preferably a wire length of an electrically conductive wire made of a shape memory alloy, is shortened or lengthened.

The actuating of the locking mechanism can comprise producing an electric contact between a current source of the pouch unloader, preferably a direct current source, and the electric power supply of the pouch.

Producing an electric contact can comprise guiding corresponding sliding contacts of the pouch and the pouch unloader past one another, wherein the electric contact is produced for a contact time during which the corresponding sliding contacts which are guided past one another are electrically conductively connected. The current supply via the contacted contacts can depend on a system controller for the contacted corresponding electric contacts releasing an electric current so that the pouch is opened. This embodiment is expedient in particular when, instead of a single pouch, a multiplicity of pouches, for example a pouch batch of a plurality of pouches, are fed to the pouch unloader, which come into contact with corresponding electric contacts of the pouch unloader, simultaneously or with a time offset, but only a single or some, but in particular not all, pouches, but optionally also all, pouches are intended to be emptied, and consequently only specific pouches are intended to be supplied with an electric current via the corresponding contacts of pouch and pouch unloader.

The pouch can be transported through the pouch unloader with a continuous movement, preferably in a uniform movement, particularly preferably at the same conveying speed at which the pouch is conveyed along an upstream and a downstream conveying section of the pouch unloader.

The two pouch bottom halves can be separated from one another after the locking mechanism has assumed the release position in the pouch unloader. In this case, the shape memory element can be exposed to the environment. Alternatively or additionally, a tunnel or a channel can be provided in the pouch bottom half which has the shape memory element and in which the shape memory element is received. As a result, the risk of damage to the locking mechanism, in particular to the shape memory element, is reduced. Preferably, the shape memory element is received in the pouch bottom half in a contact-secure and non-visible manner.

The pouch can be emptied by the separation of the pouch bottom halves and the emptied pouch can be guided out of the pouch unloader along the conveying section. In this case, the current supply of the shape memory element can be interrupted so that the shape memory element relaxes, in particular lengthens again, and the locking mechanism is transferred into the closed position.

### BRIEF DESCRIPTION OF THE DRAWINGS

Further details of the invention will be explained with reference to the following figures. In the figures:

FIG. 1 shows in a schematic representation an overhead conveyor according to the prior art;

FIG. 2 shows an exemplary embodiment of a pouch according to the invention;

FIG. 3 shows in a schematic representation a divisible pouch base according to the prior art; and

FIG. 4 shows in a schematic representation a pouch base half according to an embodiment of the invention.

### DESCRIPTION OF THE PREFERRED EMBODIMENTS OF THE INVENTION

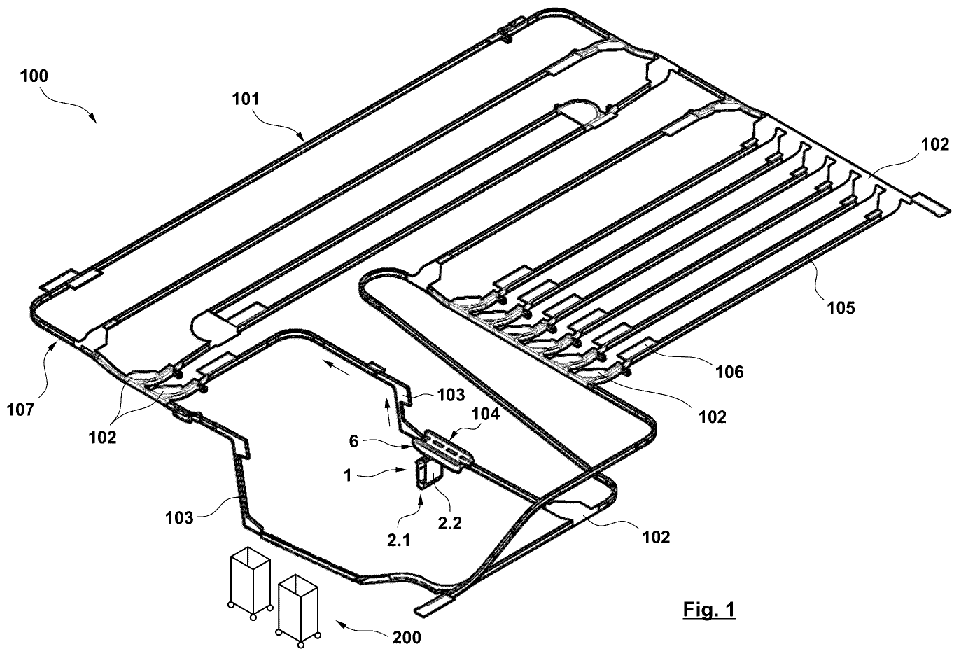

FIG. 1 shows an exemplary embodiment of a pouch sorter with an overhead conveyor 100 known from the prior art. With the overhead conveyor 100, articles 320 can be removed, for example, from a store 309, for example a high-bay store, and loaded into pouches 100 of the overhead conveyor 100. Further possible types of storage or provision can be realized, for example, by a block store, by shelf shelves, gravity shelves, continuous shelves, pallet shelves, cantilever shelves, a base storage, storage and retrieval units, horizontal carousel storage, vertical carousel storage, an automated small parts store, a storage container free storage, mobile shelves or via shuttle systems. The articles do not necessarily have to come from a store, but can also come, for example, from an automatic/manual introduction during the unloading of containers/trucks or also from a sorter. Furthermore, the transfer of the articles can take place via an interface with an identical or different type of conveyor or sorter. In the overhead conveyor 100, the articles 320 are sorted in a multi-step method and ultimately output in a predetermined sequence to packing stations 306, where the individual articles 320 are packed correspondingly to predefined shipping orders. The individual articles 320 are removed from the store 309 by a plurality of orders pickers 308 in the form of corresponding order-picking devices or in the form of personnel and the individual articles 320 removed in the course thereof are each collected in one of a plurality of transfer points 310 and combined to form individual order batches which are to be transferred to the pouch sorter. The individual articles 320 collected in the transfer points 310 are then loaded into pouches 1 of the overhead conveyor 100 via a plurality of loading stations 303, wherein the assignment of each article 320 to the respective pouch 1 is stored as long as the article 320 is located on the overhead conveyor. The loaded pouches are subsequently fed to a dynamic batch buffer 302, in which a pre-sorting of the pouches 1 is carried out. For example, the dynamic batch buffer 302 can have a plurality of buffer circuits, wherein all the pouches which are to be fed as a sorting destination to the same packing station 306 are stored in the same buffer circuit until they are discharged from the buffer circuit as a group of pouches with the same sorting destination, for example in response to a request. Preferably, a plurality of groups of pouches which are to be fed to the same packing station 306 or have the same sorting destination can be received, i.e. buffered, in each of the buffer circuits. This pre-sorting in the dynamic batch buffer 302 can take place fully automatically on the basis of at least one criterion. These criteria can relate to the departure time, an identification of the forwarding agent, the total volume of the aspects of the same shipping destination, a prioritization, a weight class, a size class and/or the like. Furthermore, a dynamic buffer 301 is connected upstream of the dynamic batch buffer 302, said dynamic buffer being fed by return runners 311 which are likewise fed to said dynamic buffer via a loading station 303. Provision can be made for the return runners 311 to be fed to the dynamic batch buffer 302 in a prioritized manner before the corresponding article 320 has to be removed again from the store 309. Furthermore, provision can be made for a separate dynamic buffer 301 to be assigned to each of the loading stations 303.

The separation of the pouches 1 according to their groups or sorting destinations takes place in a sorting matrix 304 which is connected downstream of the dynamic batch buffer 302 in terms of conveying technology and in which the pouches 1 are fed. The plurality of complete groups of pouches 1 of the same sorting destination are fed to the sorting matrix 304 in an arbitrary sequence. After passing through the sorting matrix 304, the pouches 1 leave the latter in a sort-specific manner, i.e. as a compact stack of pouches 1, wherein all the pouches 1 assigned to a group of pouches 1 with the same sorting destination are discharged from the sorting matrix 304 directly one after the other. The sorting matrix 304 is furthermore configured to additionally produce, in addition to the sort purity, a sequence of the pouches 1 within the same group, and consequently to generate a sequencing of the pouches 1. This sequencing can be provided, for example, in order to achieve a further sorting stage. Subsequently, the sequenced pouches 1 are fed to a pouch buffer 305 arranged upstream of the packing stations 306. On request by the packing stations 306, groups of sequenced pouches which belong, for example, to the same order can be discharged from the pouch buffer 305 and fed to the packing station 306 requesting the order. In the packing stations 306, the articles 320 are then removed one after the other from the incoming pouches 1 and packed as intended by the order. The empty pouches 1 are then temporarily stored in an empty pouch buffer 307 and can be fed again from there to the loading stations 303.

At a pouch unloader 104, the articles held in the pouches 1 can be removed manually, semiautomatically or fully automatically. A fully automatic pouch unloader and a pouch suitable for this are known from EP 4 168 330 A1.

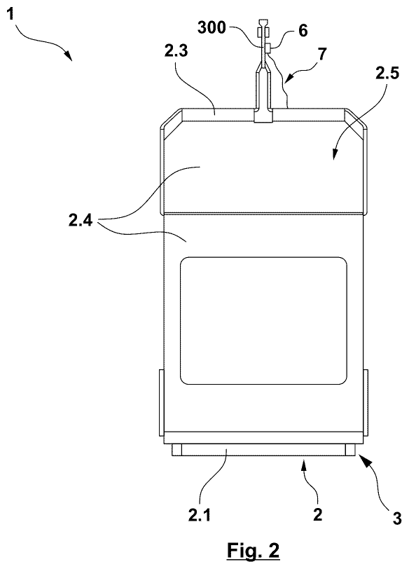

FIG. 2 shows an exemplary embodiment of a pouch 1 in the side view, which is suspended in a carrier 300. Via the carrier 300, the pouch 1 can in turn be suspended in a conveying rail (101, cf. FIG. 1). The pouch 1 has two pouch walls 2.4, which are connected to one another at the lower end to form a divisible pouch base 2 and are held at the upper end by a bracket 2.3, which on the one hand provides a loading opening 2.5 and on the other hand for suspending the pouch 1 on the carrier 300, for example a roller carrier, for moving along a conveying rail of an overhead conveyor.

At the lower end of each of the pouch walls 2.4, in each case one of the pouch base halves 2.1, 2.2 is fastened, which are releasably latched to one another by means of a locking mechanism 3.

On the carrier 300, a contact 6, for example a sliding contact, is arranged, which can come into contact with a complementary contact in a pouch unloader (104, cf. FIG. 1) in order to supply the current supply 7 of the pouch 1 with electric energy, whereupon the locking mechanism 3 is activated, in particular a shape memory element 5 is supplied with an electric current in order to transfer the locking mechanism 3 from a closed position into a release position.

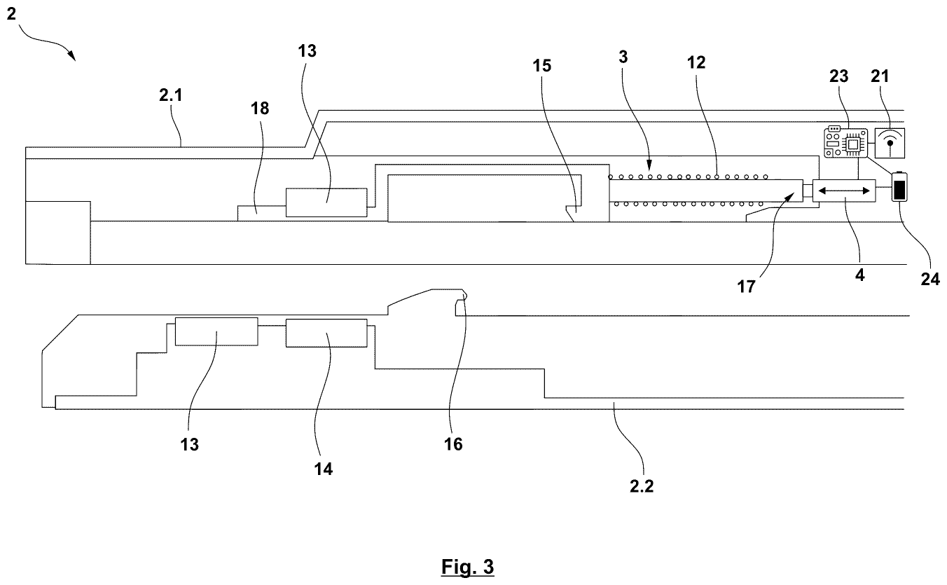

FIG. 3 shows a divisible pouch base 2 according to the prior art, with two halves 2.1, 2.2, which is suitable for the remote-controlled unlocking. The pouch base 2 could alternatively also be arranged on a pouch 1 of the arrangement according to FIG. 2 in the base region 3 and connect the two opposite pouch walls 2.4 of the pouch 1, which are oriented perpendicularly to the conveying direction, to one another. The locking mechanism 3 can have a mechanical pretension into the closed position. For this purpose, a spring element, here a spiral spring 12, is provided.

The pouch base halves 2.1, 2.2 have magnetic elements 13, 14. Preferably, all the magnetic elements 13, 14 are designed as permanent magnets. In particular, however, the magnet element 13 can also be designed as a ferromagnetic element, for example have a ferrous metal. The magnets 13, 14 have a polarity according to which magnets of complementary polarity are arranged opposite one another in the closed position of the locking element 3 while magnets of the same polarity are arranged opposite one another in the release position.

In a closed position, the actuation end 17 of the magnet slide 18 can be spaced apart from a drive 4, for example a servomotor or a solenoid, by a maximum adjustment distance by which the actuation end 17 can be adjusted between the closed position and the release position. In the closed position, the hook 15 of the magnet slide 18 engages in the undercut hook receptacle 16, wherein the undercut receptacle 16 engages under the hook 15 with a projection which forms the undercut behind which the hook 15 engages and bears against the hook 15 so that the closed position is reproducibly defined. In the release position of the magnet slide 18, the latter is as close as possible to the drive 4 so that the hook 15 of the first coupling half 5 and the undercut hook receptacle 16 of the second coupling half 6 are spaced apart from one another and disengaged so that the halves 2.1, 2.2 can be detached from one another in or against the conveying direction. To transfer the magnet slide 18, the drive 4 designed as a pulling solenoid in the example shown pulls the magnet slide 18 against the spring force of the return spring 12 out of the closed position away from the undercut hook receptacle 16, to the right relative to the representation. Alternatively, the drive 4 can also be designed as a pushing solenoid, wherein the orientation of the hook 15 and the hook receptacle 16 and the orientation of the magnets 13, 14 would be arranged correspondingly in the opposite direction. To actuate the drive 4, a control unit 23 is provided which is connected to a receiver 21 or has the latter. Furthermore, an electric energy store 24, for example a rechargeable battery, is provided in order to supply the control unit 23, the receiver 21 and the drive 4 with energy. As soon as the receiver 21 receives a signal for opening the pouch base 3 by radio, this signal is transmitted to the control unit 23 which thereupon actuates the drive 4 to transfer the magnet slide 18 from the closed position into the release position.

The closure mechanism shown in FIG. 3 is of comparatively complex design and is susceptible to malfunction in terms of handling since the operational reliability depends in particular on the reliability of the mechanism and electronics installed in the pouch base 2 and on the fact that the wireless actuation of the drive 4 takes place at the exactly correct time while the pouch moves along the conveying section at its conveying speed.

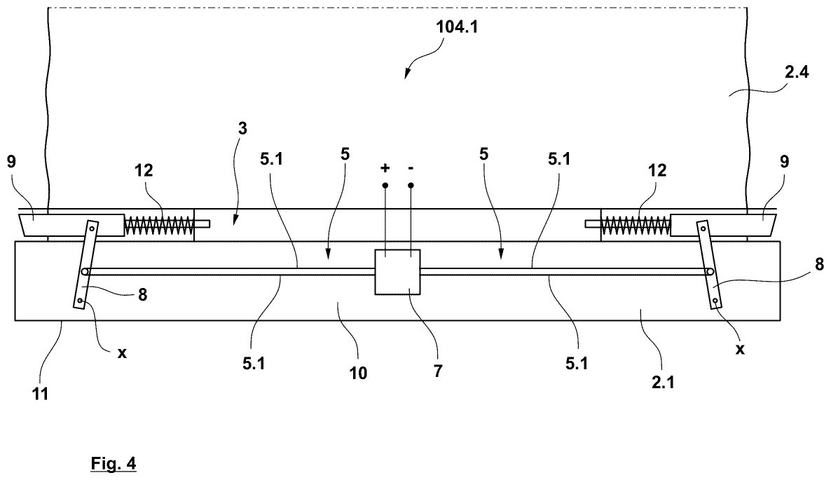

The pouch base half 2.1 shown in FIG. 4 has the locking mechanism 3 according to the invention according to one embodiment. The further pouch base half 2.2, which is not shown, can only be configured to receive the pouch base half 2.1, in particular the locking pawls 9, when the locking mechanism 3 is in the closed position.

The locking mechanism 3 has a shape memory element 5 which in the present case is formed from a wire 5.1 made of a shape memory alloy. The wire 5.1 is deflected through 180° on a lever 8 which is mounted rotatably about an axis of rotation x. The wire 5.1 ends in a power supply 7 to which the wire ends are fixed on the one hand and supplied with electric energy on the other hand.

When the wire 5.1 is supplied with an electric current, the wire 5.1 can prevent a length, in particular contract. When the power supply 7 is interrupted, the wire 5.1 can relax. The locking pawl 9, which is likewise suspended on the lever 8, is pretensioned into the closed position by a spiral spring 12.

The locking mechanism 3 is shown in FIG. 4 in the release position, i.e. when the power supply 7 is activated and the shape memory element 5 or wire 5.1 is accordingly controlled. Accordingly, the locking pawl 9 is in a retracted position. If the power supply 7 were now interrupted, the shape memory element would relax and the locking pawl 9 would emerge from the housing of the pouch base half 2.1 owing to the spring pretension 12 and could enter a recess (not shown) of the 2. Pouch base half 2.2 in order to fix the two pouch base halves 2.1, 2.2 to one another.

The shape memory element 5 can be designed as a tension spring or as a compression spring. The same applies to the spring element 12. Accordingly, the shape memory element 5 and the spring element 12 can be interchanged with one another in the sense of a kinematic reversal in embodiments of the invention.

The wire 5.1 is guided substantially exposed in the pouch base half 2.1, in particular in a cavity, in that ambient air can flow around the wire 5.1 when the pouch base 2 is open, as a result of which the emptying process is accelerated after the interruption of the power supply and the reconnection of the two pouch base halves is thus accelerated after the unloading of the pouch 1. Alternatively, the shape memory element can have a thermal insulation which is configured to reduce the heat dissipation so that the return of the blocking member from the release position into the closed position is slowed down after the interruption of the current supply.

The features of the invention disclosed in the above description, in the drawings and in the claims can be essential both individually and in any combination for the realization of the invention.

1. A pouch (1) for a pouch sorter, comprising wherein the pouch (1) has a divisible pouch base (2) with two pouch base halves (2.1, 2.2) which are connected to one another via a locking mechanism (3) and can be released from one another in a release position of the locking mechanism (3), wherein the locking mechanism (3) can be adjusted back and forth between a closed position and the release position, wherein the locking mechanism (3) has a shape memory element (5, 12) which can be supplied with an electric current via an electric power supply (7) of the pouch (1).

2. The pouch (1) according to claim 1, in which the locking mechanism (3) has a spring element (5, 12) with which the locking mechanism (3) is pretensioned into the closed position, wherein the shape memory element (5, 12) is configured to transfer the locking mechanism (3) into the release position against a pretension of the spring element (5, 12) depending on its current supply.

3. The pouch (1) according to claim 1, which has at least one electric contact (6), preferably at least one sliding contact, for connecting a current source, preferably a direct current source, to the electric power supply (7).

4. The pouch (1) according to claim 3, in which the power supply (7) has at least one electric conductor, for example an electric cable, with which the shape memory element (5, 12) is connected to the at least one electric contact (6).

5. The pouch (1) according to claim 1, in which the electric power supply (7) has at least one receiver of a wireless, preferably an inductive, energy transmission, by which the power supply (7) is supplied with electric energy.

6. The pouch (1) according to claim 1, in which the locking mechanism (3) has on opposite sides of one of the pouch bottom halves (2.1, 2.2), preferably on opposite end faces, in each case a locking pawl (9), on which the shape memory element (5, 12), or shape memory element (5, 12) of the locking mechanism (3) separate for the two locking pawls (9), is arranged.

7. The pouch (1) according to claim 1, in which the locking mechanism (3) has at least one lever (8) which is pivotable about an axis of rotation (x) and on which the shape memory element (5, 12) and a locking pawl (9) are arranged spaced apart from one another in the longitudinal direction of the lever (8).

8. The pouch (1) according to claim 7, in which the locking mechanism (3) has on opposite sides of one of the pouch bottom halves (2.1, 2.2), preferably on opposite end faces, in each case a lever (8) which is pivotable about an axis of rotation (x) and on which the shape memory element (5, 12), or shape memory element (5, 12) of the locking mechanism (3) separate for the two levers (8), and a locking pawl (9) are arranged spaced apart from one another in the radial direction with respect to the axis of rotation (x).

9. The pouch (1) according to claim 1, in which the shape memory element (5, 12) is of wire-shaped design and/or has an electrically conductive wire (5.1) made of a shape memory alloy, in particular is designed as a spring made of an electrically conductive wire (5.1) made of a shape memory alloy, particularly preferably a spiral spring or a helical spring.

10. The pouch (1) according to claim 6, in which the locking pawl (9) extends out of the pouch bottom half (2.1, 2.2) over one of two opposite end faces of one of the two pouch bottom halves (2.1, 2.2) when the locking mechanism (3) assumes the closed position, wherein preferably the shape memory element (5, 12), in particular an electrically conductive wire (5.1) made of a shape memory alloy, extends at least in sections and preferably over its entire length at an angle, preferably perpendicularly, to the end face.

11. The pouch (1) according to claim 1, in which the two pouch bottom halves (2.1, 2.2) are of plate-shaped design, wherein the shape memory element (5, 12), in particular an electrically conductive wire (5.1) made of a shape memory alloy, extends in the interior and at least in sections, preferably over its entire length, parallel to one of the two pouch bottom halves (2.1, 2.2).

12. The pouch (1) according to claim 1, in which the shape memory element (5, 12), in particular an electrically conductive wire (5.1) made of a shape memory alloy, is arranged exposed in the interior of a cavity (10) of the pouch bottom half (2.1), wherein the cavity (10) is open at a connecting side (11), via which the pouch bottom half (2.1) bears against the other pouch bottom half (2.2) when the pouch bottom halves (2.1, 2.2) are connected to one another, when the pouch bottom halves (2.1, 2.2) are detached from one another.

13. A pouch sorter with a multiplicity of pouches (1) according to claim 1, wherein the pouch sorter has an overhead conveyor (100) with a multiplicity of carriers (300), which are conveyed along a conveying rail (101) of the overhead conveyor (100) and into which in each case one of the multiplicity of pouches (1) is suspended.

14. A method for the automatic pouch unloading in a pouch sorter, wherein the method has the steps:
a. conveying at least one pouch (1), preferably a multiplicity of pouches (1), particularly preferably a batch of a specific number of pouches, along a conveying section (101) of a pouch sorter, wherein the pouch (1) is designed according claim 1;
b. feeding the pouch (1) into a pouch unloader (104) of the pouch sorter along the conveying section (101), wherein at the pouch unloader (104) the locking mechanism (3) is actuated to assume the release position by the shape memory element (5, 12) being supplied with an electric current from the pouch unloader (104) via the power supply (7).

15. The method according to claim 14, in which the supplying comprises heating of the shape memory element (5, 12), wherein a length of the shape memory element (5, 12), preferably a wire length of an electrically conductive wire (5.1) made of a shape memory alloy, is shortened or lengthened.

16. The method according to claim 14, wherein the actuating comprises producing an electric contact between a current source (104.1) of the pouch unloader (104), preferably a direct current source, and the electric power supply (7) of the pouch (1).

17. The method according to claim 16, in which producing an electric contact comprises guiding corresponding sliding contacts (6) of the pouch (1) and the pouch unloader (104) past one another, wherein the electric contact is produced for a contact time during which the corresponding sliding contacts (6) which are guided past one another are electrically conductively connected.

18. The method according to claim 14, in which the pouch (1) is transported through the pouch unloader (104) with a continuous movement, preferably with a uniform movement, particularly preferably at the same conveying speed at which the pouch (1) is conveyed along an upstream and a downstream conveying section (101) of the pouch unloader (104).

19. The method according to claim 14, in which the two pouch bottom halves (2.1, 2.2), after the locking mechanism has assumed the release position in the pouch unloader (104), are separated from one another, wherein the shape memory element (5, 12) is exposed to the environment.

20. The method according to claim 19, in which the pouch (1) is emptied by the separation of the pouch bottom halves (2.1, 2.2) and the emptied pouch (1) is guided out of the pouch unloader (104) along the conveying section (101), wherein the current supply of the shape memory element (5, 12) is interrupted so that the shape memory element (5, 12) relaxes, in particular lengthens again, and the locking mechanism (3) is transferred into the closed position.
